(19) United States
(12) Patent Application Publication
(10) Pub. No.: US 2012/0141070 A1
(43) Pub. Date: Jun. 7, 2012

(54) CONNECTOR ASSEMBLY WITH IMPROVED STRUCTURE ON A BRACKET FOR MOUNTING CONNECTORS

(75) Inventor: JAMES M. SABO, Harrisburg, PA (US)

(73) Assignee: HON HAI PRECISION INDUSTRY CO., LTD., Tu-Cheng (TW)

(21) Appl. No.: 12/960,590

(22) Filed: Dec. 6, 2010

(51) Int. Cl. G02B 6/38

(52) U.S. Cl. 385/60

(57) ABSTRACT

A connector assembly includes a connector, a bracket for mounting the connector and a coupler for mating with the connector and the bracket. The connector includes an outer housing through which a latching arm and a ferrule both extend. The bracket includes a middle portion, a rear base and a pair of guiding blocks extending forwardly from the middle portion. The ferrule is directly positioned between the pair of guiding blocks. The rear base is associated with a deformable arm to abut against the outer housing to limit a front-to-back movement of the outer housing. The coupler includes a pair of guiding slots formed at lateral sides thereof for guiding insertion of the pair of guiding blocks thereinto.

### BACKGROUND OF THE INVENTION

1. Field of the Invention

The present invention relates to connector assemblies with brackets for receiving connectors, and more particularly to connector assemblies with improved guiding structures formed on the brackets to be precisely inserted into couplers. The instant application relates to a copending application titled “WAVEGUIDE CONNECTOR WITH IMPROVED STRUCTURE FOR POSITIONING WAVEGUIDE INTO FERRULE” and having the same filing date, the same applicant and the same assignee therewith.

2. Description of Related Art

MPO cable connectors are usually used for connecting daughter cards and a backplane for optical signal transmission. U.S. Pat. No. 6,819,855 B2 issued to Fujiwara et al. on Nov. 16, 2004 discloses such a connector system. Referring to FIG. 1 of this patent, the connector system includes a frame, a plurality of daughter cards received in the frame in a parallel manner, a bracket mounted on each daughter card, a backplane mounted at a rear side of the frame, a coupler received in the backplane, and a pair of fiber cable connectors coupled with each other along opposite directions via the bracket and the coupler. The bracket is mounted to extend beyond an edge of the corresponding daughter card and includes a central channel with a pair of locking arms extending into the channel to lock with one of the fiber cable connectors. The coupler includes a first chamber for receiving the bracket and a second chamber for receiving the other fiber cable connector. However, it is difficult to observe whether the fiber cable connector is inserted to reach the final position or not, since the channel is surrounded by four peripheral walls. Besides, with the bracket inserted into the first chamber of the coupler, a central protrusion of the bracket is received in the first chamber, and top and bottom walls of the bracket are abutting against corresponding top and bottom sides of the coupler. However, with the interference or obstruction of the central protrusion, it is difficult to precisely position the top and the bottom walls of the bracket with respect to the coupler.

Hence, connector assemblies with improved guiding structures formed on brackets to be precisely inserted into couplers are desired.

### BRIEF SUMMARY OF THE INVENTION

The present invention provides a connector assembly including a connector, a bracket for mounting the connector and a coupler for mating with the connector and the bracket. The connector includes a tube outer housing through which a latching arm and a ferrule both extend. The bracket includes a middle portion, a rear base extending backwardly from the middle portion, and a pair of guiding blocks cantileveredly extending forwardly from the middle portion. The ferrule is positioned between the pair of guiding blocks. The rear base comprises at least one deformable arm extending upwardly to abut against the outer housing and to limit a front-to-back movement of the outer housing. The coupler includes a first receiving opening to receive the ferrule, an abutting wall in communication with the first receiving opening to lock with the latching arm, and a pair of guiding slots formed at lateral sides thereof to guide insertion of the pair of guiding blocks thereinto.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of a waveguide connection system employing waveguide connectors connecting a backplane and a plurality of daughter cards in accordance with a preferred embodiment of the present invention;

FIG. 2 is another perspective view of the waveguide connection system as shown in FIG. 1, while taken from another aspect;

FIG. 3 is a partly exploded view of the waveguide connection system as shown in FIG. 1, from which a frame is disassembled;

FIG. 4 is a perspective view of a part waveguide connection system showing a plurality of waveguide connectors mounted on the daughter card via a plurality of brackets;

FIG. 5 is a partly exploded view of the waveguide connection system as shown in FIG. 4, showing one of the brackets disassembled from the daughter card;

FIG. 6 is another partly exploded view of the waveguide connection system as shown in FIG. 5;

FIG. 7 is a perspective view of a connector assembly showing one waveguide connector mounted on the bracket, and the other waveguide connector received in a coupler;

FIG. 8 is a side view of the connector assembly as shown in FIG. 7 with an additional PCB mounted beneath the bracket;

FIG. 9 is a perspective view of the connector assembly as shown in FIG. 7, with a pair of waveguide connectors both inserted into the coupler from opposite directions, while separating the bracket from the corresponding waveguide connector;

FIG. 10 is an exploded view of the connector assembly as shown in FIG. 9;

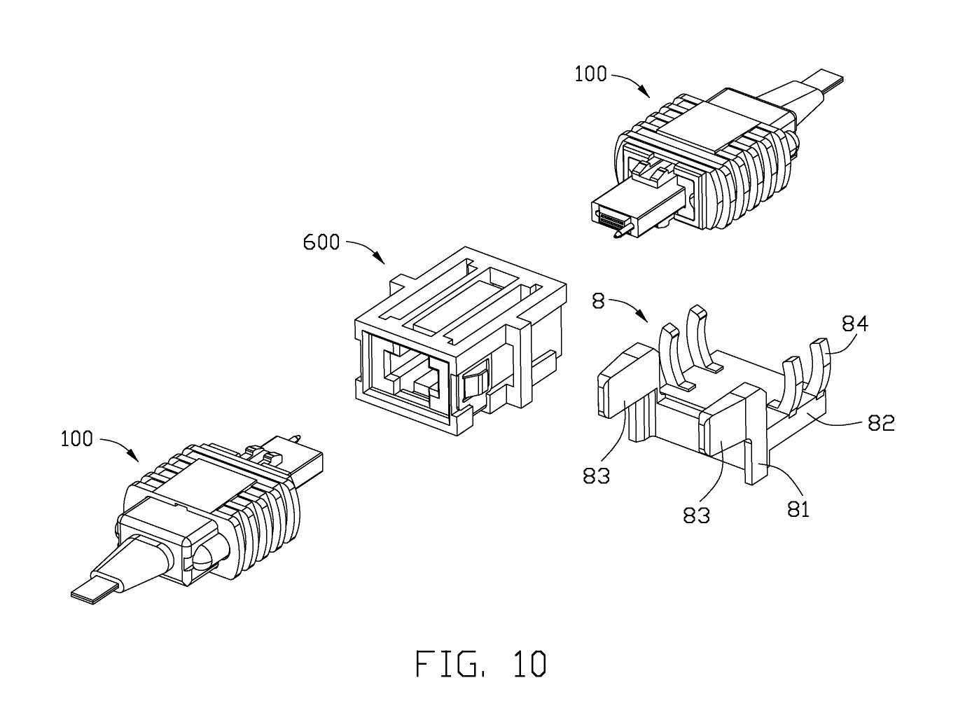

FIG. 11 is an assembled view of the connector assembly as shown in FIG. 9;

FIG. 12 is a disassembled view of a part waveguide connection system showing a pair of waveguide connectors associated with the coupler before mounted to the backplane;

FIG. 13 is an assembled view of the waveguide connection system as shown in FIG. 12;

FIG. 14 is a schematic cross-sectional view of the waveguide connection system taken along line 14-14 of FIG. 13, showing the pair of waveguide connectors coupled with each other;

FIG. 15 is a cross-sectional view of the waveguide connection system taken along line 15-15 of FIG. 13;

FIG. 16 is a perspective view of the waveguide connector as shown in FIG. 12;

FIG. 17 is another perspective view of the waveguide connector as shown in FIG. 16;

FIG. 18 is a partly assembled view of the waveguide connector as shown in FIG. 16 before an outer housing mounted thereto;

FIG. 19 is a perspective view of an inner housing as shown in FIG. 18;

FIG. 20 is a further exploded view of the waveguide connector as shown in FIG. 16;

FIG. 21 is an exploded view of the waveguide connector as shown in FIG. 20;

FIG. 22 is another exploded view of the waveguide connector similar to FIG. 21, while taken from another aspect;

FIG. 23 is a prospective view of a ferrule and waveguides separated from the ferrule;

FIG. 24 is a cross-sectional view of the waveguide connector taken along line 24-24 of FIG. 16;

FIG. 25(a) is a cross-sectional view of the waveguide connector showing the outer housing assembled onto the inner housing under an original status;

FIG. 25(b) is a cross-sectional view of the waveguide connector similar to FIG. 25(a), while the outer housing is driven to be backwardly moveable with respect to the original status;

FIG. 26 is a schematic cross-sectional view of the waveguide connector taken along line 26-26 of FIG. 16 while remaining the whole ferrule, showing relationships of main components;

FIG. 27 is a perspective view of a pair of waveguide connectors before insertion into a coupler in accordance with a second embodiment of the present invention;

FIG. 28 is a perspective view of with the pair of waveguide connectors inserted into the coupler;

FIG. 29 is a schematic view of the pair of waveguide connectors mating with each other under the guiding of a pair of alignment guides while housings of the coupler are removed;

FIG. 30 is a cross-sectional view of the coupler taken along line 30-30 of FIG. 27; and

FIG. 31 is an exploded view of the coupler.

### DETAILED DESCRIPTION OF THE PREFERRED EMBODIMENT

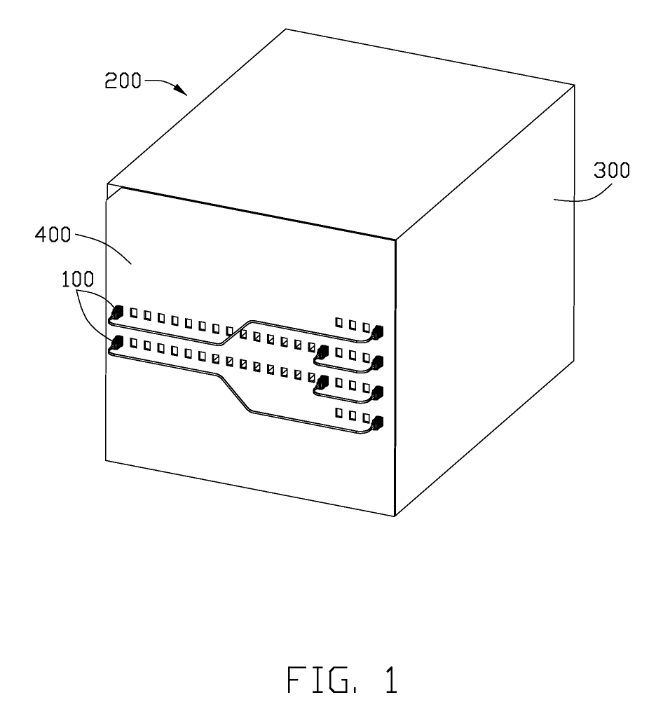

Reference will now be made to the drawing figures to describe the preferred embodiment of the present invention in detail. FIGS. 1-4 illustrate a connection system 200 including a frame 300, a backplane 400 mounted at a rear side of the frame 300, a plurality of daughter cards 500 parallel residing in the frame 300, and a plurality of connectors 100 coupled with each other for connecting the daughter cards 500 and the backplane 400. According to the preferred embodiment of the present, the connectors 100 are waveguide connectors 100 for light transmission between the backplane 400 and the daughter cards 500. The backplane 400 and the daughter cards 500 are PCBs.

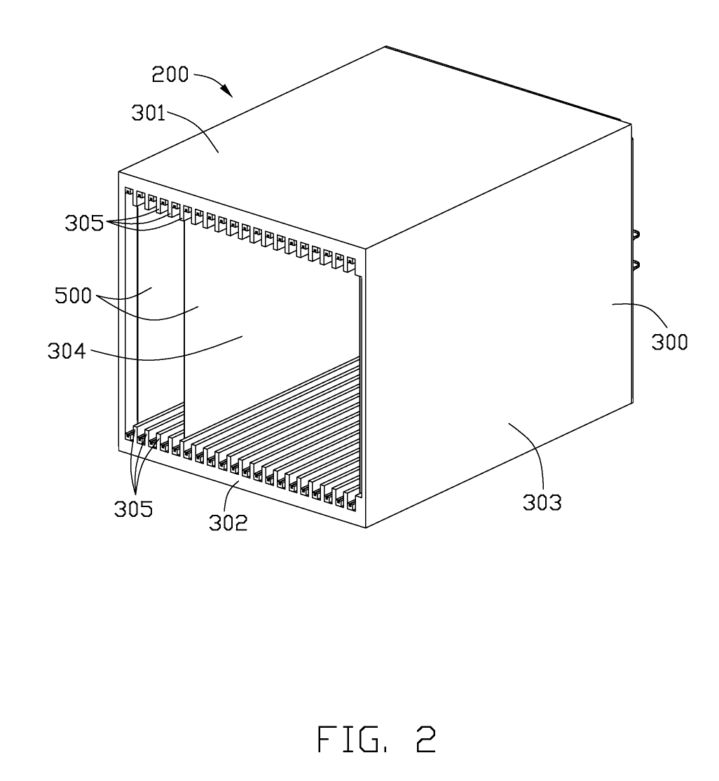

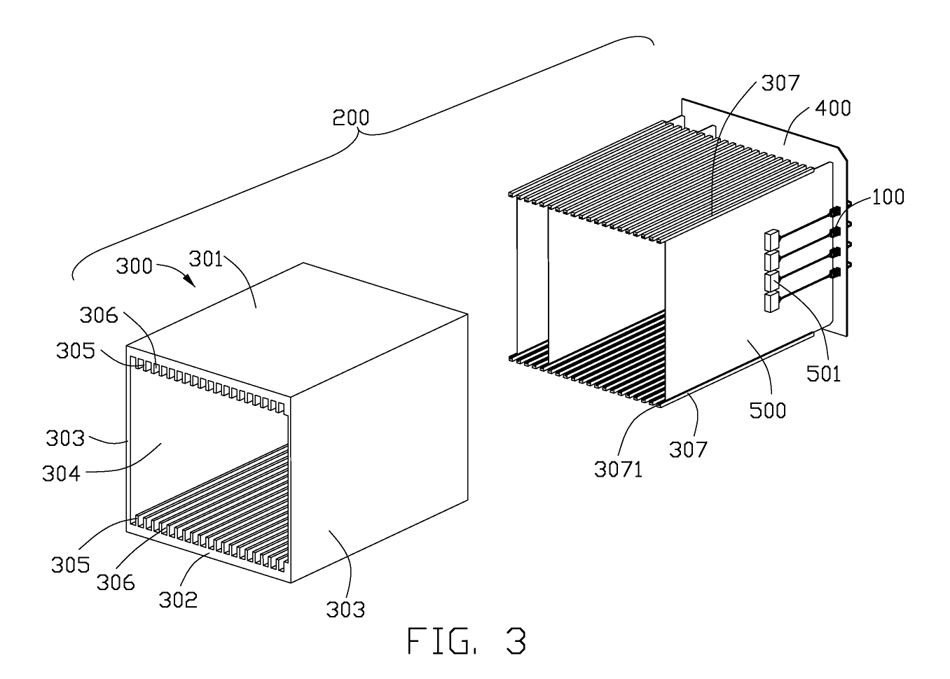

Referring to FIGS. 2 and 3, the frame 300 is of rectangular shape and includes a top wall 301, a bottom wall 302, and a pair of side walls 303 connecting the top and the bottom walls 301, 302 to jointly form a receiving chamber 304. Inner sides of the top and the bottom walls 301, 302 include a plurality of ribs 305 and a plurality of slots 306 formed by adjacent ribs 305 and the ribs 305 with adjacent side wall 303. A plurality of slats 307 are employed to position the daughter cards 500 in the frame 300. The slots 306 formed on the top wall 301 are aligned with the corresponding slots 306 formed on the bottom wall 302. The slats 307 are received in the corresponding slots 306 formed on the top and the bottom walls 301, 302. Each slat 307 includes a slit 3071, as shown in FIG. 3, for receiving one of upper and lower edges of the daughter card 500. Referring to FIGS. 1 to 3, in assembly, the slats 307 are fixed in the slots 306 along a horizontal direction and then the daughter cards 500 are inserted into the slits 3071 so that the daughter cards 500 can be clipped by the slats 307 for fixation. Alternatively, the slats 307 are mounted on the upper and the lower edges of each daughter card 500 which is then inserted into the slots 306. The daughter cards 500 are separated from each other and are arranged in a parallel manner. Each daughter card 500 is perpendicular to the backplane 400 and comprises a plurality of optoelectronic (OE) modules 501 as shown in FIG. 3.

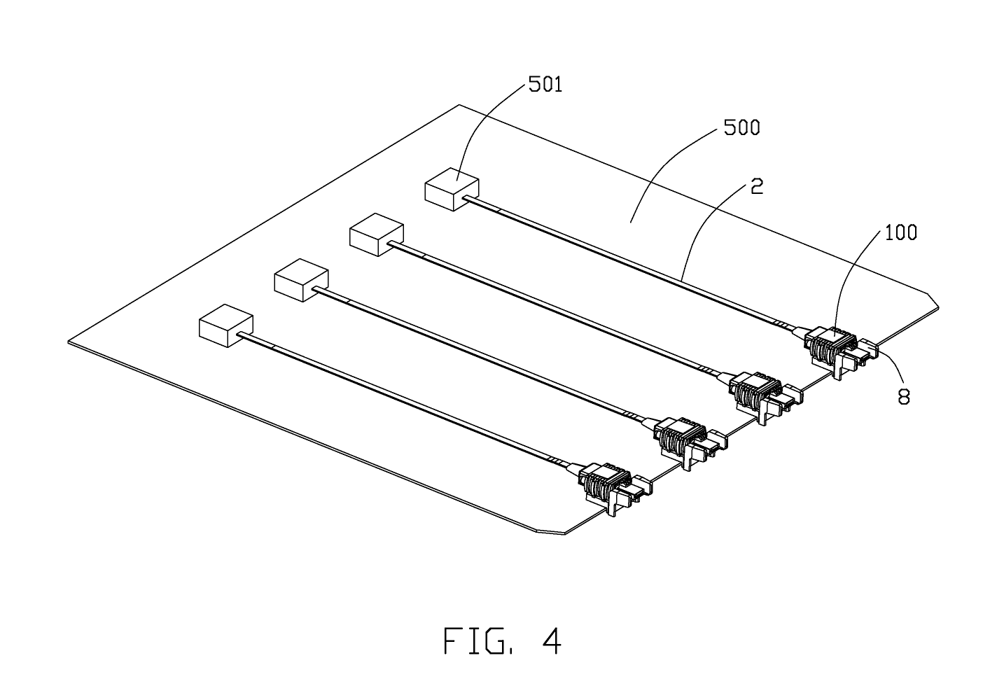

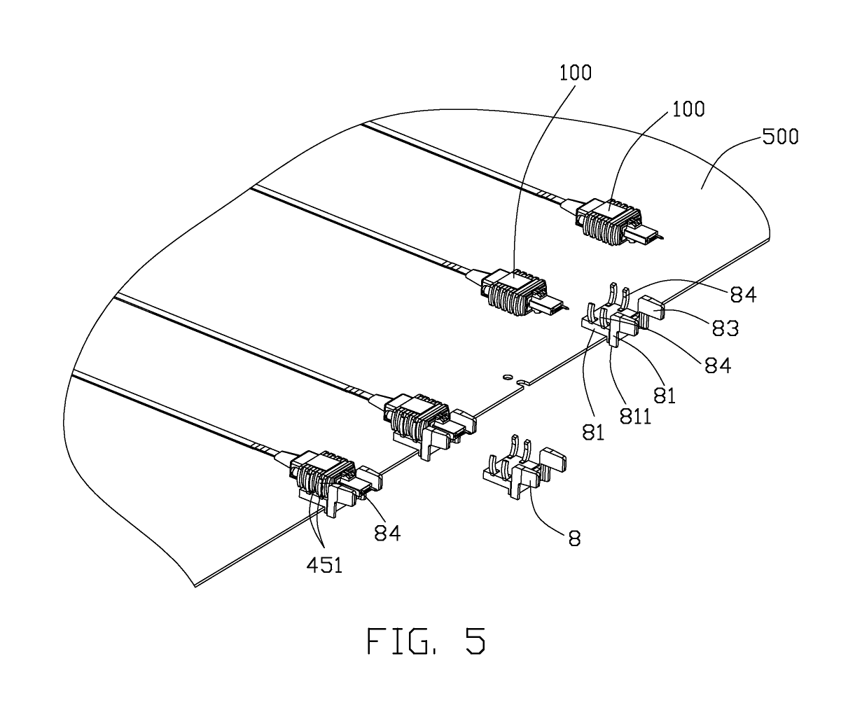

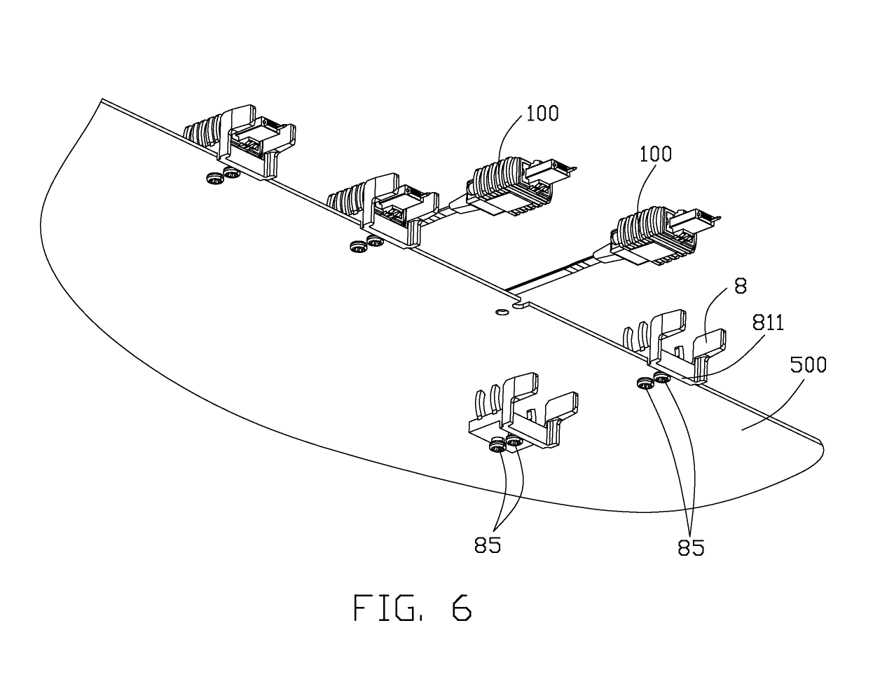

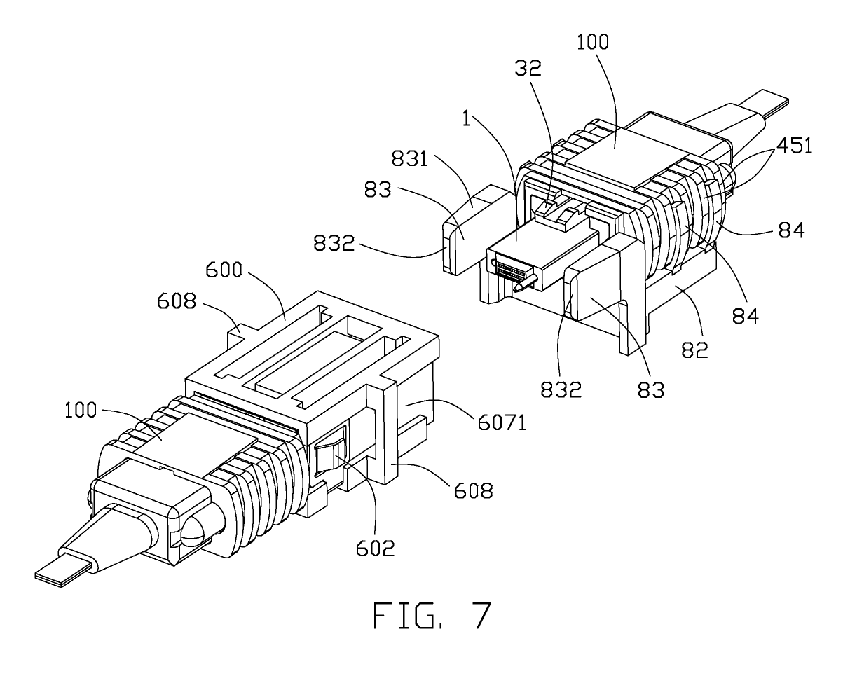

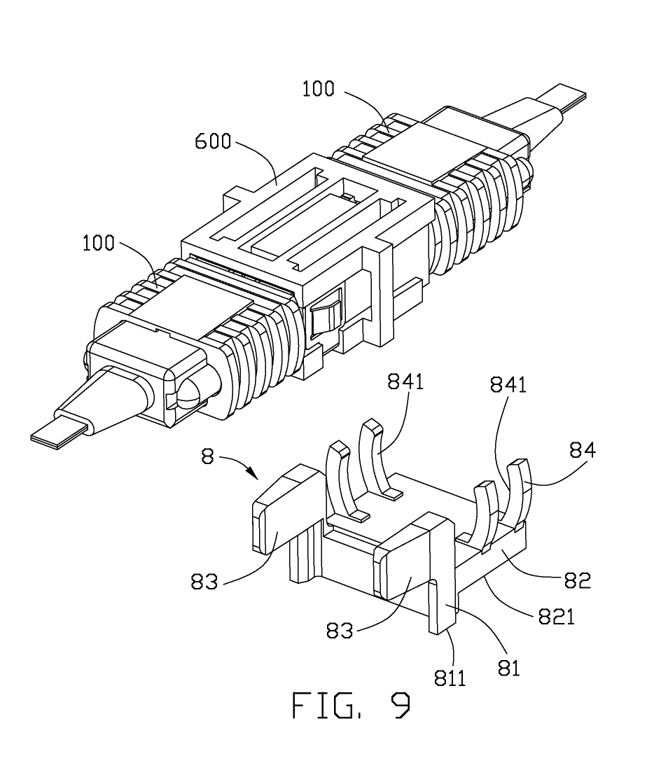

Referring to FIGS. 4 to 6, a plurality of brackets 8 are mounted on the daughter card 500 for receiving multiple waveguide connectors 100 which are connected to the OE modules 501. According to the illustrated embodiment of the present invention, a pair of screws 85 are provided for fixing each bracket 8 onto the daughter card 500. As shown in FIGS. 5 and 9, each bracket 8 includes a middle portion 81, a rear base 82 extending backwardly from the middle portion 81 and a pair of guiding blocks 83 cantileveredly extending forwardly from the middle portion 82. The middle portion 81 includes a bottom surface 811 lower than the daughter card 500. The rear base 82 is associated with a plurality of deformable arms 84 located at lateral sides thereof. The rear base 82 includes a mounting surface 821 higher than the bottom surface 811 of the middle portion 81 for mounting the daughter card 500. Each deformable arm 84 is curved and includes a concave inner surface 841. The pair of guiding blocks 83 extend forwardly from a top side of the middle portion 81. Each guiding block 83 includes a contractive free end 832 for being easy inserted into a coupler 600, as shown in FIG. 7. Besides, each guiding block 83 is substantially rectangular shaped with its height larger than its width, that is to say, each guiding block 83 is mainly located in a vertical plane. According to the illustrated embodiment of the present invention, the brackets 8 are made of insulative materials, such as plastic, rubber, etc., and the deformable arms 84 are integrally formed with the rear base 82. However, in alternative embodiments, the deformable arms 84 can be replaced with metal such as stamped steel clips, or the like, and the deformable arms 84 can be separately made and then securely assembled to the rear base 82. In assembly, the corresponding waveguide connectors 100 are mounted to the brackets 8 from a top-to-bottom direction, and the waveguide connectors 100 are clipped by the deformable arms 84 in order to limit front-to-back and bottom-to-top movements of the waveguide connectors 100, which will be detailed hereinafter.

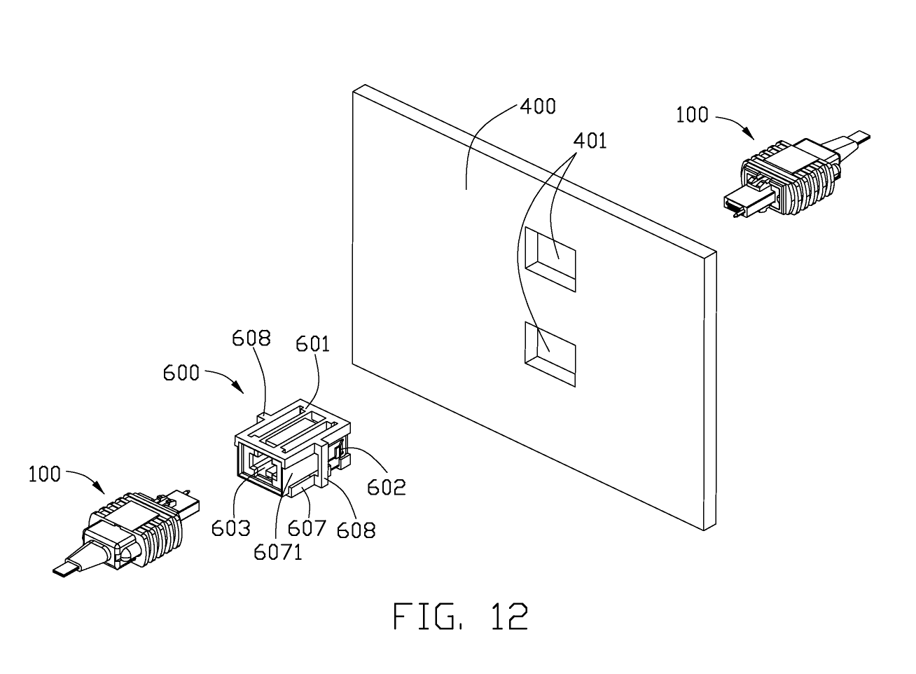

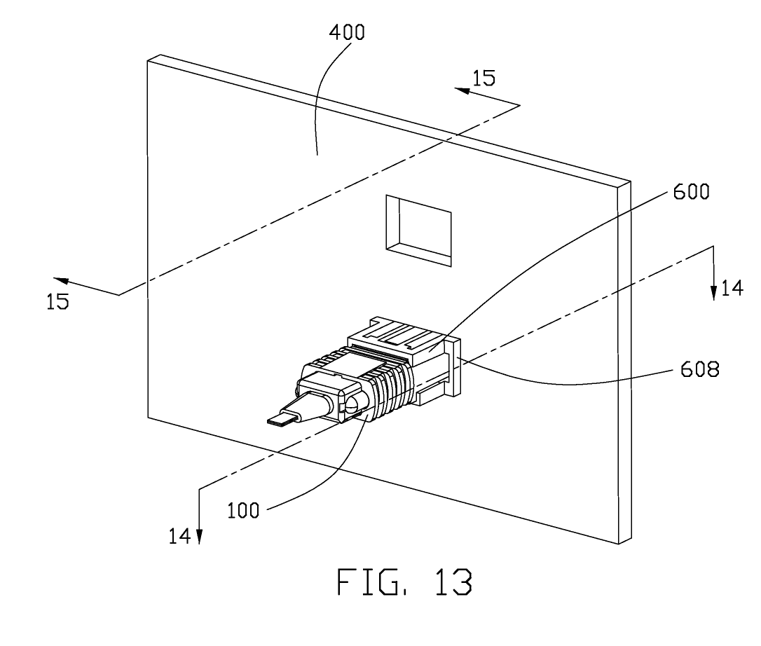

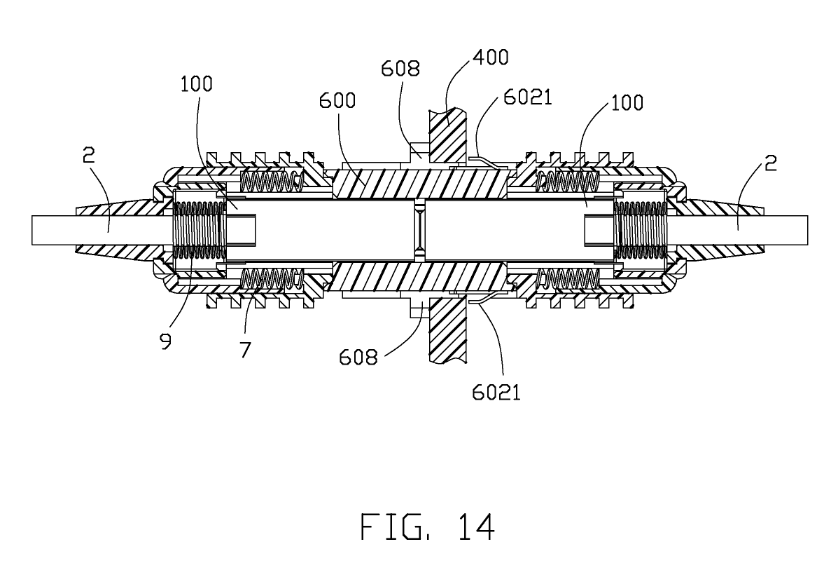

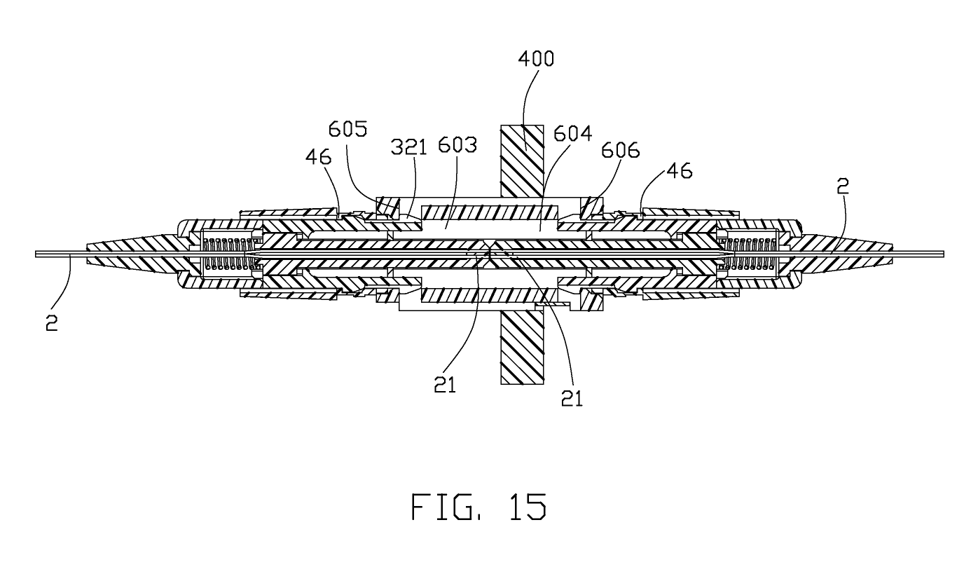

Referring to FIGS. 12 to 15, the backplane 400 defines a plurality of mounting holes 401 for mounting a plurality of couplers 600 as shown in FIGS. 12 and 13. Each coupler 600 includes a housing 601 and a U-shaped metal spring 602 attached to the housing 601. As shown in FIG. 14, the metal spring 602 includes a pair of tabs 6021 sidewardly protruding therefrom. When the coupler 600 is inserted into the mounting hole 401 of the backplane 400 till a pair of protrusions 608 engaging a front side of the backplane 400, the pair of tabs 6021 extend through the mounting hole 401 to reach a rear side opposite to the front side. The pair of tabs 6021 are adapted for abutting against the rear side of the backplane 400 in order to prevent the coupler 600 from falling off from the mounting hole 401. The housing 601 defines a first receiving cavity 603 throughout one end thereof and a second receiving cavity 604 communicating with the first receiving cavity 603 and throughout the other end thereof. The housing 601 includes a pair of first abutting walls 605 exposed to the first receiving cavity 603 and a pair of second abutting walls 606 exposed to the second receiving cavity 604. Under this arrangement, when a pair of waveguide connectors 100 are inserted into the first and the second receiving cavities 603, 604 from opposite directions, the pair of waveguide connectors 100 are lockable with the first and the second abutting walls 605, 606 for fixation, as shown in FIG. 15. As a result, the pair of waveguide connectors 100 can meet inside the coupler 600 for stable light transmission, as shown in FIG. 14. Besides, the housing 601 further includes a pair of side walls 607 with the protrusions 608 formed thereon. The pair of side walls 607 each defines a guiding slot 6071 horizontally extending through the corresponding protrusion 608.

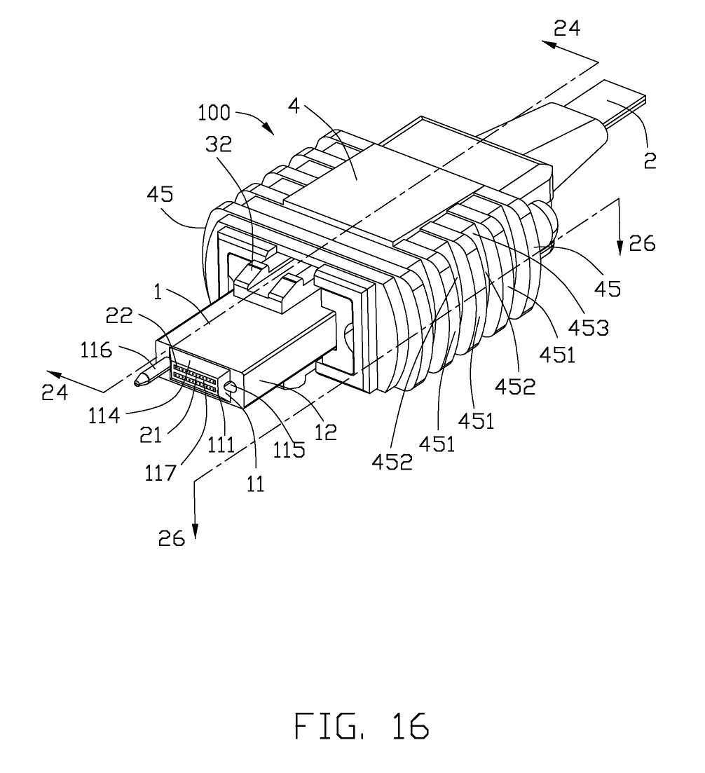

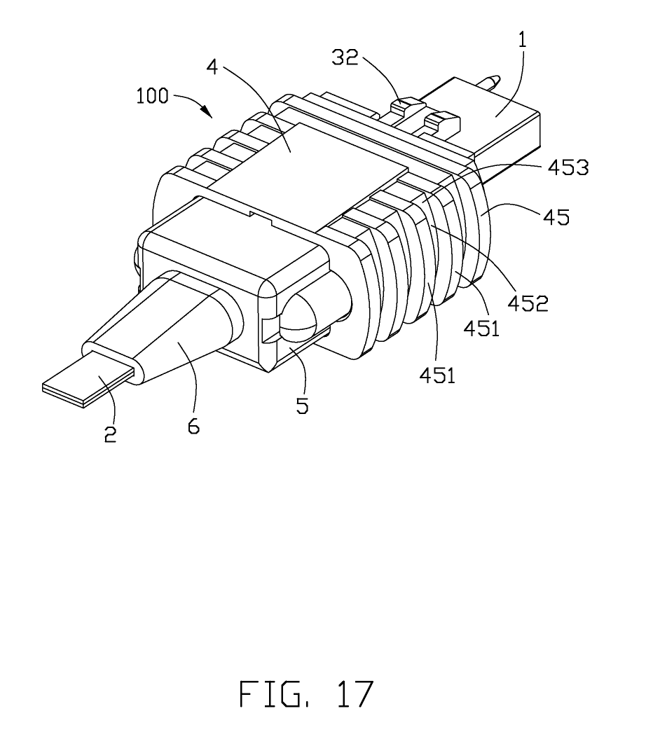

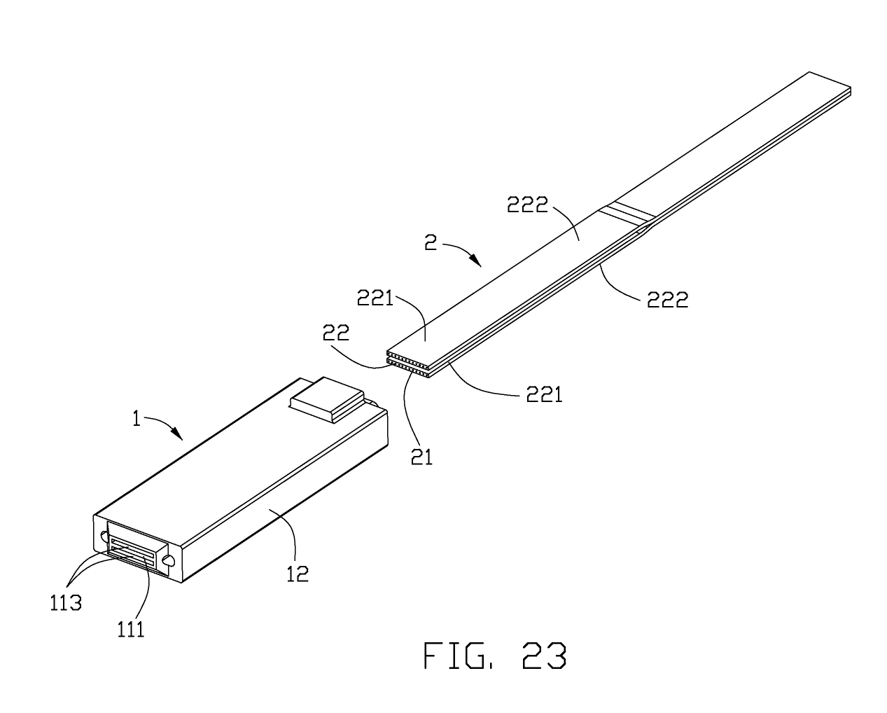

Referring to FIGS. 16 to 26, each waveguide connector 100 includes a ferrule 1, a plurality of waveguides 2 inserted into the ferrule 1, an inner housing 3 for the ferrule 1 partly extending therethrough, an outer housing 4 slideably mounted on the inner housing 3, an outer boot 5 locking with the inner housing 3, and an inner boot 6 partly received in the outer boot 5. The detailed structures of each component will be detailedly described.

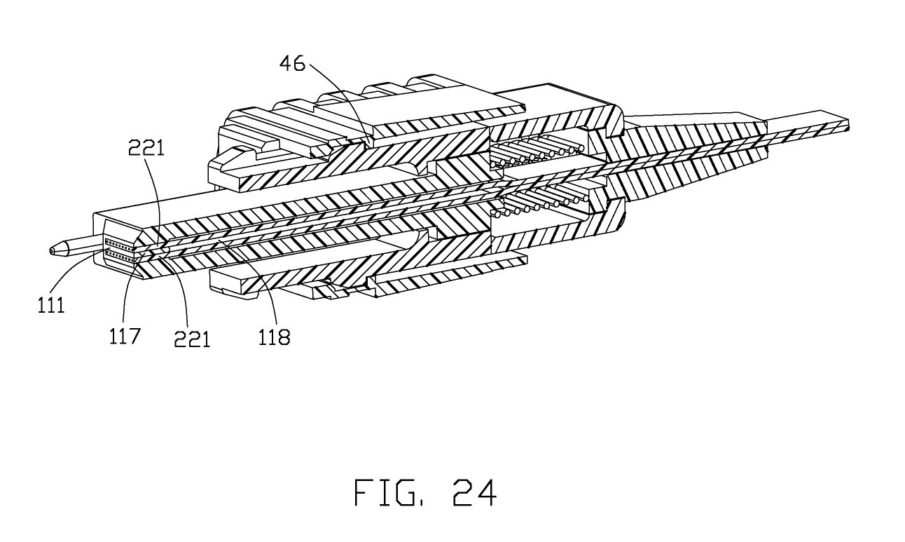

Referring to FIGS. 16 and 21 to 24, the ferrule 1 includes a front mating surface 111, a rear surface 112 opposite to the front mating surface 111, first and second front passageways 113 extending through the front mating surface 111, and a rear passageway 118 extending through the rear surface 112. The first and the second front passageways 113 are parallel to each other and are in communication with the rear passageway 118. The first and the second front passageways 113 are separated from each other by a partition wall 117, as shown in FIG. 24. Each of the first and the second front passageways 113 is thinner than the rear passageway 118. The ferrule 1 has a width larger than its height so as to be mainly located in a horizontal plane perpendicular to the vertical plane. The ferrule 1 includes a rectangular body 12 and a contractive protrusion 11 integrally extending forwardly from a front surface 120 of the body 12. The front mating surface 111 and the rear surface 112 are formed on the contractive protrusion 11 and the body 12, respectively. The contractive protrusion 11 comprises four slant side surfaces 114. A pair of holes 115 are formed at the joints of the front surface 120 and the corresponding slant surfaces 114, as best shown in FIG. 16, wherein one of the holes 115 is fitted with a guiding post 116 and the other hole 115 is empty.

The body 12 includes an upper surface 121, a lower surface 122, and a pair of position blocks 123 protruding beyond the upper and the lower surfaces 121, 122, respectively. The pair of first and second front passageways 113 are stacked one above the other and are separated by the partition wall 117 located therebetween. Each rectangular passageway 113 includes four inner surfaces for positioning the waveguides 2.

Referring to FIGS. 16, 23 and 24, according to the illustrated embodiment of the present invention, first and second waveguides 2 are provided to be inserted into the ferrule 1. The first and the second waveguides 2 are joint together at a rear side and are split at a front side for being easily assembled into the ferrule 1. Each waveguide 2 includes a plurality of rectangular cores 21 for light transmission and a cladding layer 22 integrally enclosing the cores 21. Front parts 221 of the cladding layers 22 are configured to be received in the first and the second front passageways 113, respectively, along a rear-to-front direction. The cores 21 are exposed at the front mating surface 111 of the ferrule 1, as shown in FIG. 16. The cores 21 and the cladding layers 22 are of rectangular shape. Rear parts 222 of the cladding layers 22 of the first and the second waveguides 2 reside in the rear passageway 118, as shown in FIG. 24. The cladding layers 22 each comprise four peripheral sides which are so limited by four inner surfaces of the front passageways 113, respectively, when the waveguides 2 are inserted into the ferrule 1. However, according to the illustrated embodiment of the present invention, the rear parts 222 of the cladding layers 22 are separated a distance from the rear passageway 118 as shown in FIG. 24, in order that the waveguides 2 can overcome smaller resistance during insertion into the ferrule 1.

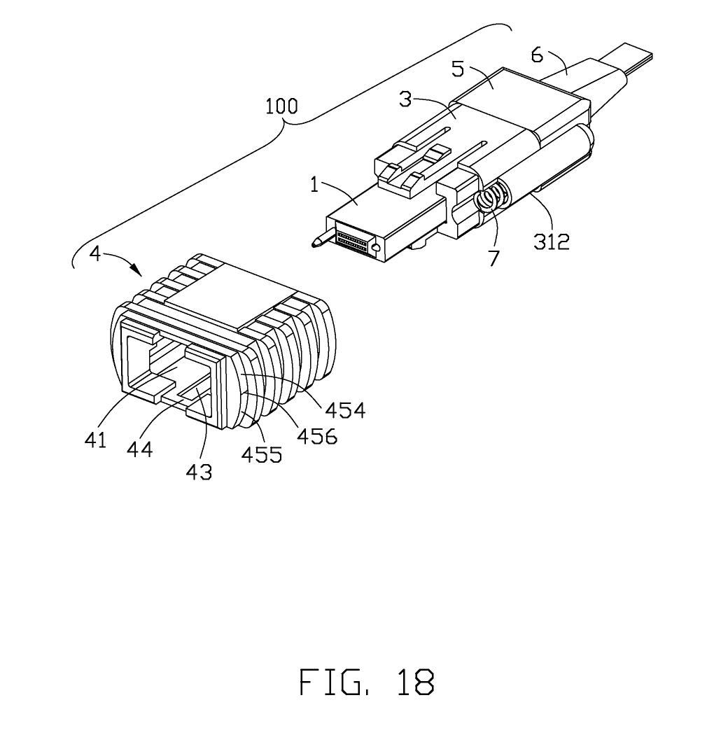

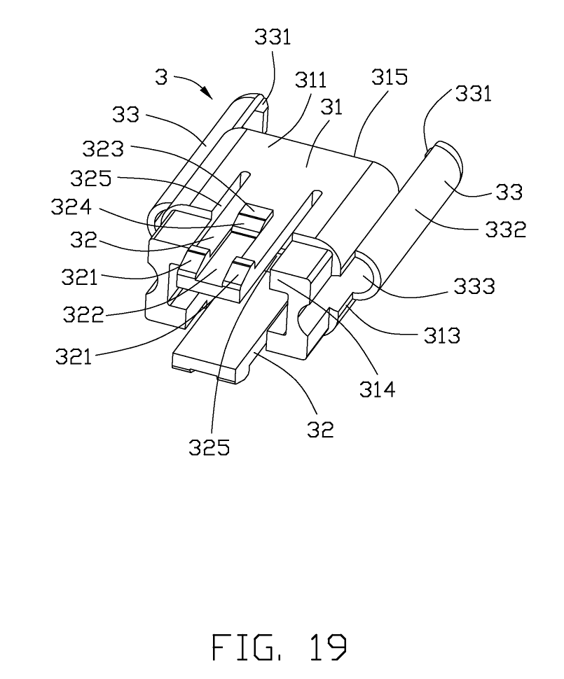

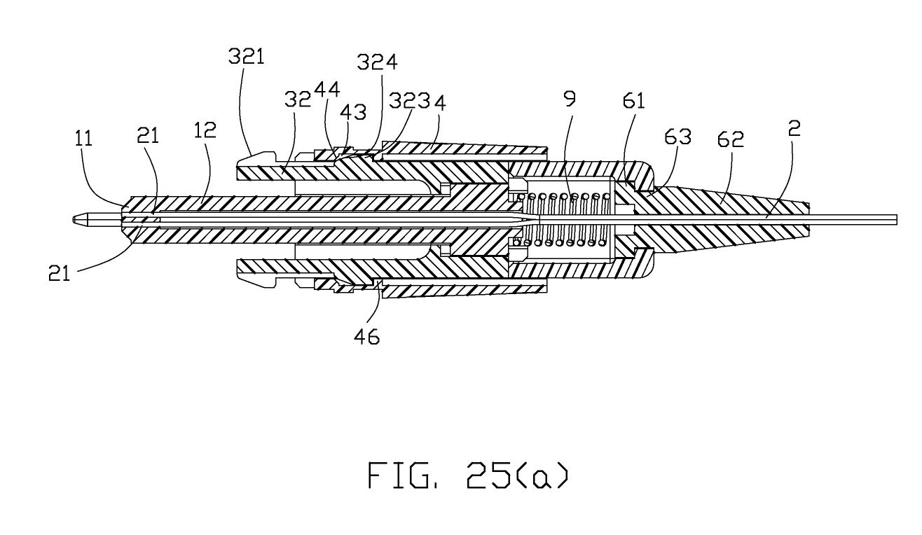

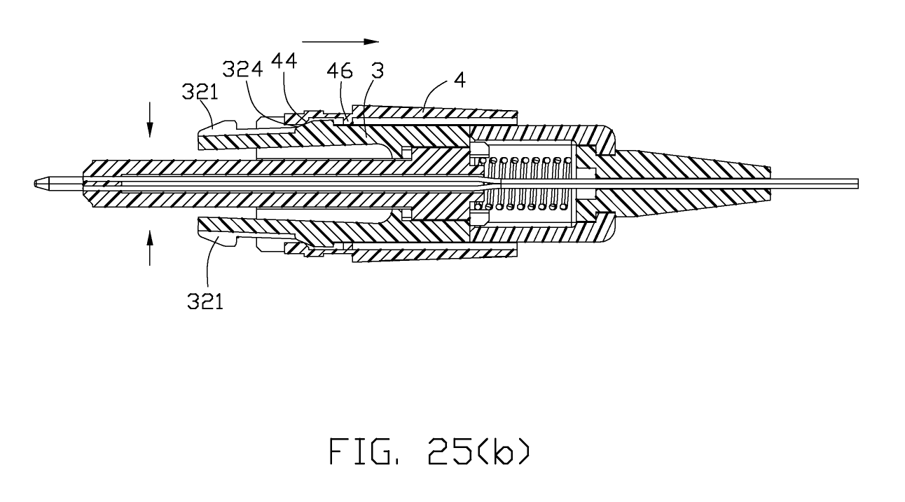

Referring to FIGS. 18-22, the inner housing 3 includes a sleeve 31 to receive the ferrule 1, a pair of upper and lower latching arms 32 extending forwardly from the sleeve 31, and a pair of latching arms 33 extending backwardly from the sleeve 31 to lock with the outer boot 5. The sleeve 31 includes a top wall 311, a bottom wall 312, a pair of side walls 313, and opposite front and rear sides 314, 315. The upper and the lower latching arms 32 are respectively formed on the top and the bottom walls 311, 312, and cantileveredly extend beyond the front side 314 of the sleeve 31. The pair of latching arms 33 are respectively formed on the side walls 313, and cantileveredly extend beyond the rear side 315 of the sleeve 31. Each latching arm 32 includes a pair of locking protrusions 321 forwardly extending beyond the outer housing 4 for locking with the corresponding first and the second abutting walls 605, 606, as shown in FIG. 15, when the waveguide connector 100 is inserted into the coupler 600. An opening 322 is formed between the pair of locking protrusions 321 in each latching arm 32. The latching arm 32 further comprises a block 323 aligned with the opening 322. As shown in FIGS. 19, 25(a) and 25(b), the block 323 is located at the rear of the locking protrusions 321 and comprises a front cam surface 324 for slideably abutting against the outer housing 4 when the outer housing 4 moves backwardly with respect to the inner housing 3 so as to deform the pair of latching arms 32 towards each other. According to the illustrated embodiment of the present invention, the cam surface 324 is slant. Besides, a pair of slits 325 are formed through the front side 314 of the sleeve 31 under an arrangement that the latching arm 32 is disposed between the pair of slits 325. As a result, the length of the latching arm 32 is prolonged and the elasticity of the latching arm 32 is improved, accordingly.

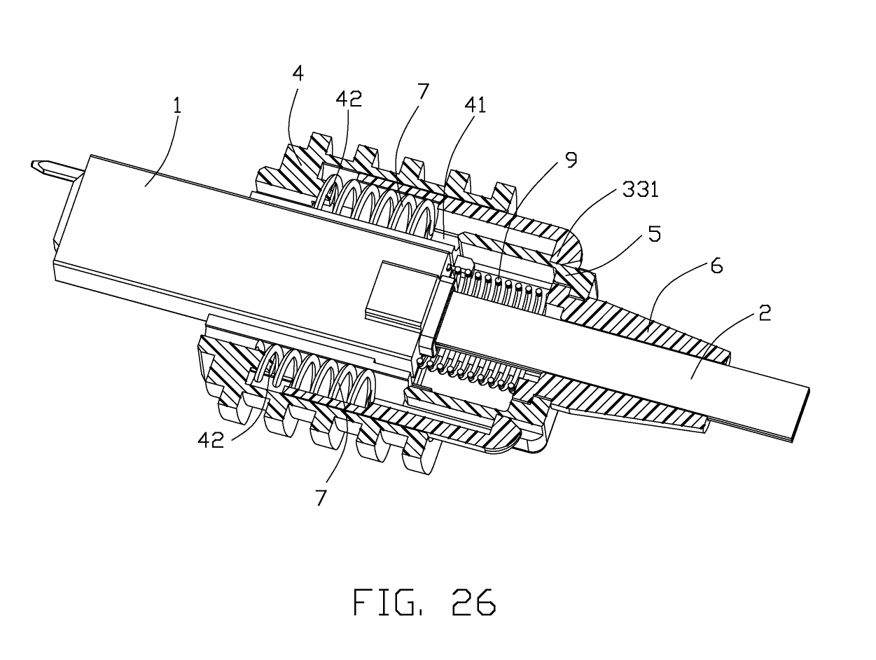

Referring to FIGS. 19 and 26, each latching arm 33 includes a hook 331 formed at a distal end thereof to lock with the outer boot 5 in order to combine the inner housing 3 with the outer boot 5. Each latching arm 33 has an arced peripheral surface 332 and defines with the sidewall 313 a receiving hole 333 to accommodate a coiled spring 7. As shown in FIG. 26, the pair of coiled springs 7 are sandwiched between the outer housing 4 and the inner housing 3 so as to provide reasonable elasticity for the outer housing 4 retractable with respect to the inner housing 3 along a horizontal direction.

The outer housing 4 is tube shaped and includes a central cavity 41 for the inner housing 3 mounted therethrough, a pair of mounting posts 42 extending into the cavity 41 for positioning the coiled springs 7, and a pair of guiding slots 43 formed on upper and lower inner sides thereof for mating with the block 323 of the inner housing 3. When the outer housing 4 is assembled to the inner housing 3 with the pair of coiled springs 7 compressed therebetween, the blocks 323 slide in the corresponding guiding slots 43. Ultimately, a pair of limit protrusions 46 of the outer housing 4 get over the blocks 323 and resist against the corresponding blocks 323, so that the outer housing 4 is prevented forward to disengage from the inner housing 3, as shown in FIGS. 15, 24 and 25(a). Besides, due to the deformation of the coiled springs 7, the outer housing 4 is moveable backwardly with respect to the inner housing. In this process, the coiled springs 7 are driven to be further compressed, and the front cam surface 324 of each block 323 is slideably pressed by an engaging wall 44 which is directly exposed to the guiding slot 43, so as to deform the pair of latching arms 32 towards each other.

Referring to FIGS. 16 to 18, the outer housing 4 includes a pair of side walls 45 each comprising a plurality of ribs 451 and a plurality of positioning slots 452 formed by the adjacent ribs 451 which are located at the same side. A convex surface 453 is formed in each positioning slot 452 and includes an upper part 454, a lower part 455 and an outmost line 456 formed by the upper and the lower parts 454, 455, as best shown in FIG. 18.

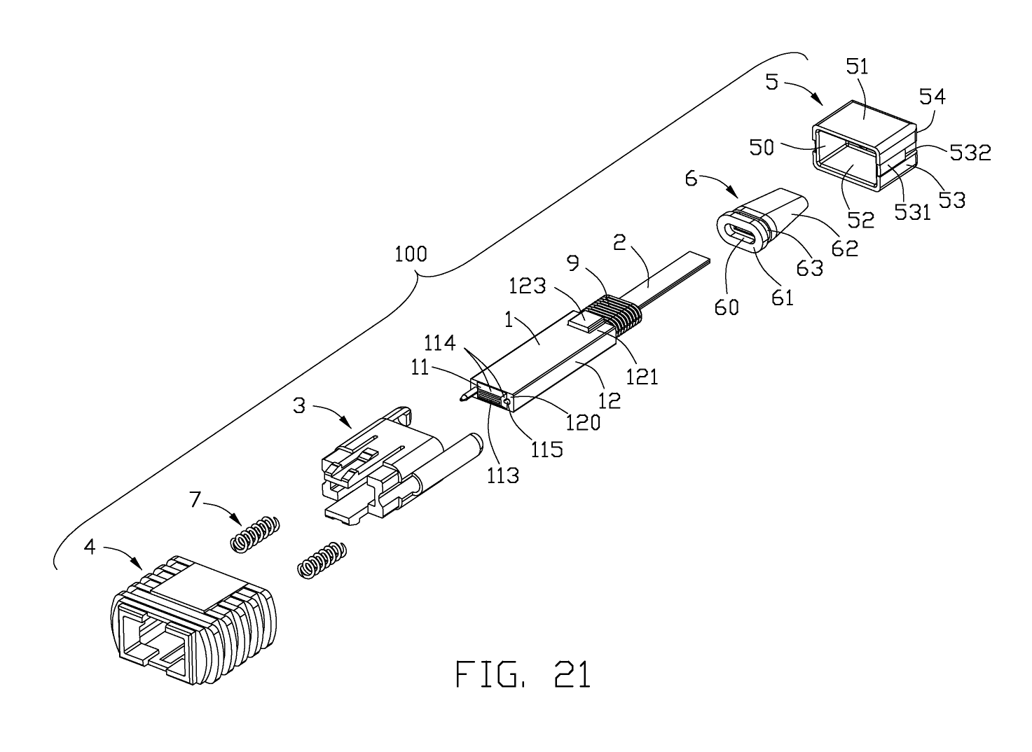

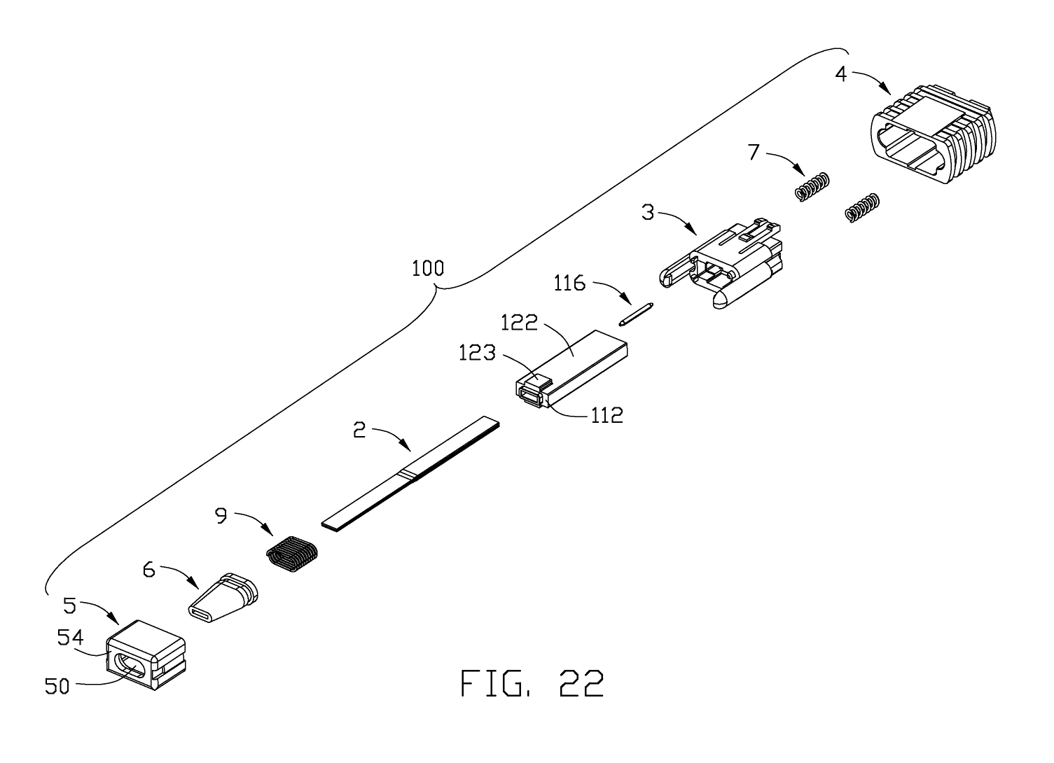

Referring to FIGS. 21 and 22, the outer boot 5 is rectangular shaped and includes a top wall 51, a bottom wall 52, a pair of side walls 53 connecting the top wall 51 and the bottom wall 52, and a rear wall 54. A receiving space 50 is defined by the above-mentioned peripheral walls and further extending through the rear wall 54. Each side wall 53 defines a guiding slot 531 throughout a front edge thereof, and a abutting wall 532 at the rear of the guiding slot 531.

Referring to FIGS. 21-26, the inner boot 6 is made of rubber and includes a front portion 61, a rear portion 62 and a neck 63 between the front portion 61 and the rear portion 62. A flat channel 60 is formed through the inner boot 6 along the horizontal direction for receiving the waveguides 2.

In assembly, small quantity of heat-curable epoxy (not shown) is placed into the rectangular passageways 113 through the rear surface 112 of the ferrule 1 for lubrication, if needed. The waveguides 2 are then inserted into the corresponding passageways 113 along the rear-to-front direction till the waveguides 2 protrude slightly beyond the front mating surface 111 of the ferrule 1, as shown in FIG. 18. Under this condition, the four peripheral sides of each cladding layer 22 are so limited by the corresponding four inner surfaces of the rectangular passageway 113 for precisely alignment. The ferrule 1 is formed in one-piece for strong structure and easy manufacture. According to the illustrated embodiment of the present invention, equal forces can be ensured to automatically align the waveguides 2 to the ferrule 1, and attaching the waveguides 2 to the ferrule 1 is expected to be much more manufacturing-friendly as there is no need to visually inspect to confirm the light-transmitting cores 21 are precisely aligned in such process. After the step of inserting, heat is applied to cure the waveguides 2 so that they can be fixed in the passageways 113 of the ferrule 1. During insertion of the waveguides 2 into the passageways 113, end-surfaces of the waveguides 2 are easily polluted/damaged such as by the heat-curable epoxy, so as to be unsuitable for light transmission. According to the illustrated embodiment of the present invention, in order to avoid this shortcoming, the waveguides 2 slightly extending beyond the front mating surface 111 of the ferrule 1 are then polished substantially flush with the front mating surface 111, so that the rectangular cores 21 and the cladding layers 22 are new and are exposed at the front mating surface 111, as shown in FIG. 5.

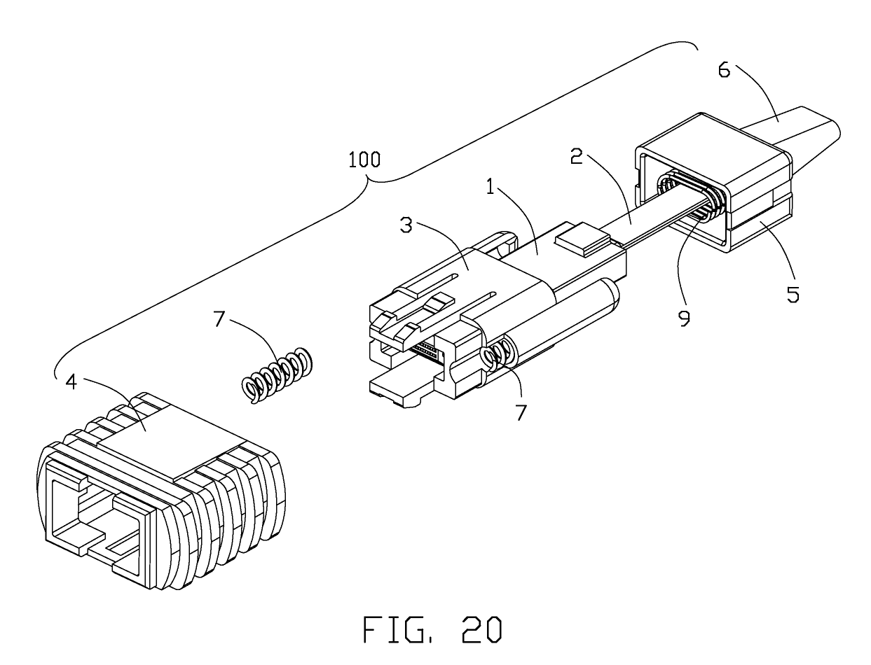

As shown in FIG. 20, the pair of coiled springs 7 are inserted into the receiving holes 333 of the inner housing 3 along the front-to-back direction. Referring to FIGS. 25(a) to 26, the outer housing 4 is then slideably mounted onto the inner housing 3 with the coiled springs 7 sandwiched therebetween. The pair of latching arms 32 are substantially parallel to the ferrule 1 and are located at upper and lower sides of the ferrule 1. The inner boot 6 is inserted through the receiving space 50 of the outer boot 5 along the front-to-back direction till the front portion 61 abutting against the rear wall 54. Under this condition, the neck 63 of the inner boot 6 is locked by the rear wall 54 and the rear portion 62 extends beyond the rear wall 54.

As shown in FIGS. 18, 21 and 25(a), a flat coiled spring 9 is mounted through the rear side of the waveguides 2 which is then inserted into the flat channel 60 of the inner boot 6 till the waveguides 2 protrude beyond the rear portion 62. The inner housing 3 is then slideably mounted to lock with the outer boot 5.

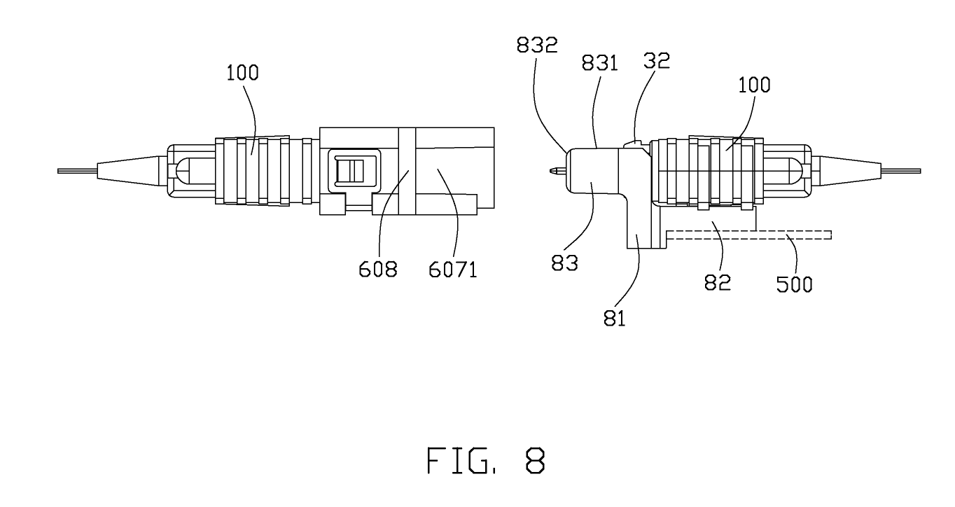

As shown in FIGS. 4-7, according to the illustrated embodiment of the present invention, some waveguide connectors 100 are mounted to the bracket 8 along the top-to-bottom direction till to be clipped by the deformable arms 84. Each deformable arm 84 is received in the corresponding positioning slot 452 and is limited by the adjacent ribs, so that a movement of the waveguide connector 100 along the front-to-back direction can be restricted. Besides, the concave inner surface 841 of each deformable arm 84 is configured to attach the convex surface 453 in each positioning slot 452. The free end of the each deformable arm 84 presses against the upper part 454 of the convex surface 453 in order to limit a bottom-to-top movement of the outer housing 4. Under this condition, as shown in FIGS. 7 and 8, a top surface 831 of each guiding block 83 is higher than an upper surface of the ferrule 1 which is located between the pair of guiding blocks 83.

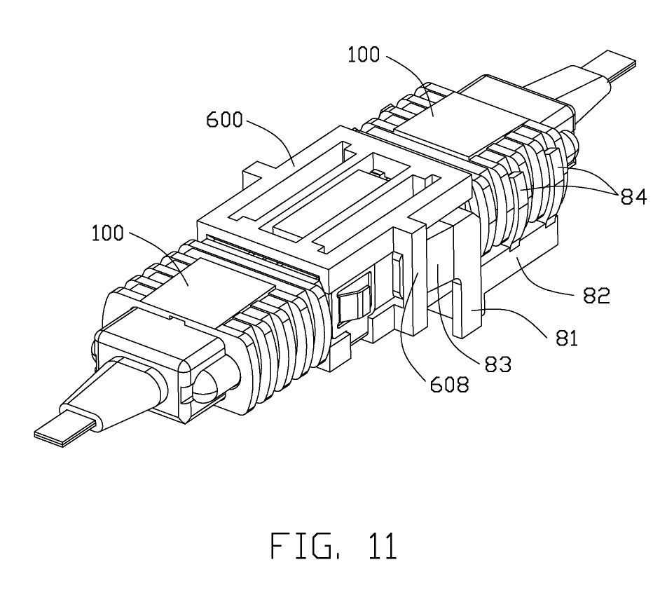

In connection, as shown in FIGS. 7, 11, 13 to 15, the couplers 600 are mounted into the mounting holes 401 of the backplane 400, then a pair of waveguide connectors 100 are inserted into the couplers 600 along opposite directions, among which one of the waveguide connectors 100 is already fixed to the bracket 8. The pair of guiding blocks 83 are inserted into the guiding slots 6071 until the guiding blocks 83 are outwardly limited by the protrusions 608. When the guiding of the guiding post 116 of one waveguide connector 100 is inserted into the corresponding hole 115 of the other waveguide connector 100, the pair of waveguide connectors 100 are precisely aligned as well as the cores 21. The waveguides 2 of the pair of waveguide connectors 100 floatably meet at the front mating surfaces 111, under the action of the flat coiled springs 9, for light transmission.

Take the waveguide connector 100 which is mounted on the bracket 8 for example, with the waveguide connector 100 fully inserted into the first receiving cavity 603 of the coupler 600, the pair of locking protrusions 321 lock with the corresponding first and the second abutting walls 605, 606 of the coupler 600. However, when the waveguide connector 100 is disassembled from the coupler 600, a force may be applied to drive the outer housing 4 moveable along a direction opposite to the insertion direction. As shown in FIG. 25(b), in this process, the front cam surfaces 324 are slideably pressed by the stop wall 44 of the outer housing 4 so as to deform the pair of latching arms 32 towards each other. As a result, such deformation results in disassembly of the latching arms 32 and the first and the second abutting walls 605, 606, and the waveguide connector 100 can be removed from the coupler 600. However, under the released elasticity of the coiled springs 7, the outer housing 4 is accordingly driven to an original position.

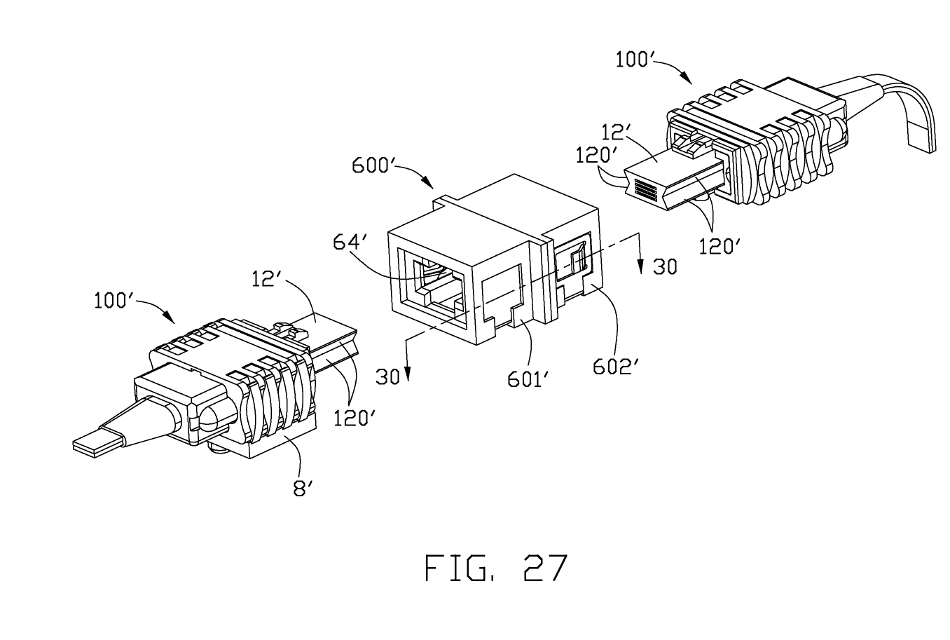

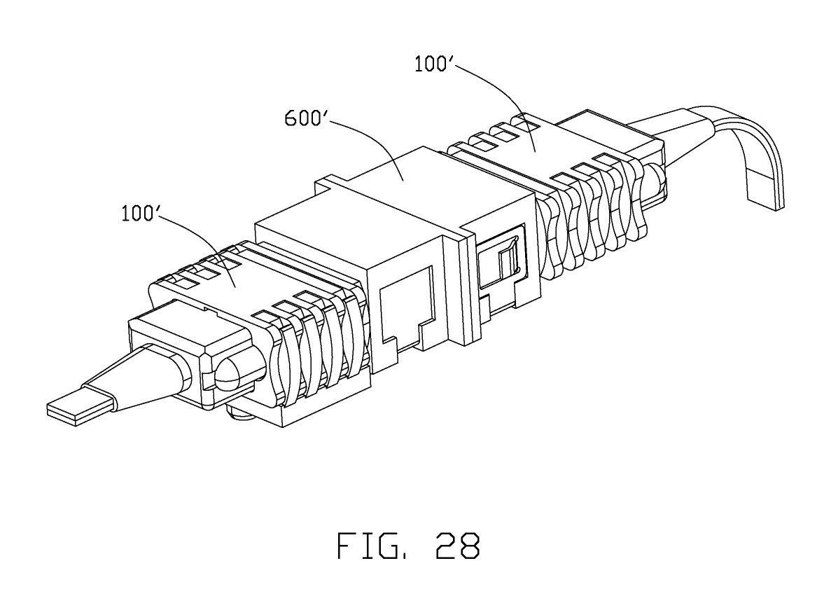

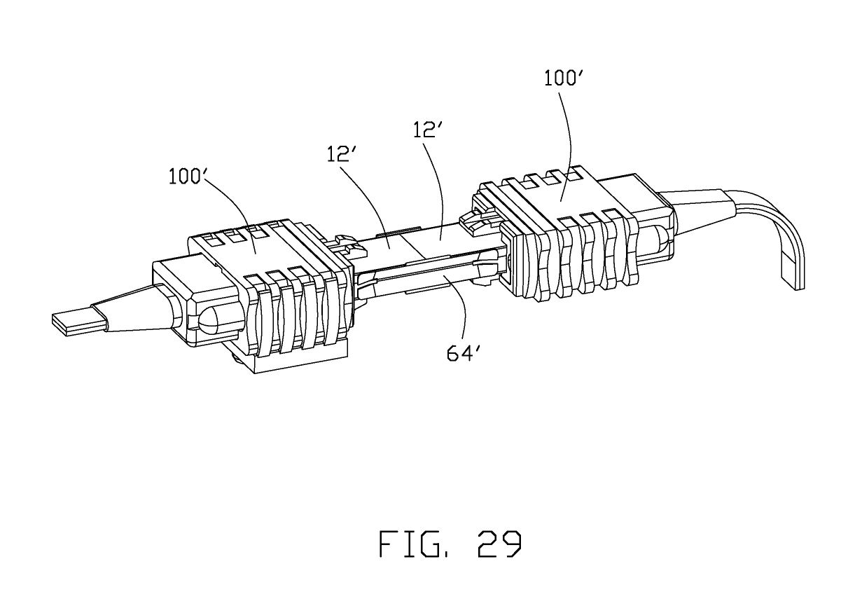

Referring to FIGS. 27 to 30, a pair of waveguide connectors 100′ and a coupler 600′ for matching the pair of waveguide connectors 100′ are disclosed according to the second embodiment of the present invention. Each waveguide connector 100′ is similar to the above-described waveguide connector 100 wherein the differences between them mainly focus the guiding structures, which will be detailedly described hereinafter.

Each waveguide connector 100′ includes a ferrule 12′ defining a pair of V-shaped grooves 120′ formed on lateral sides thereof. As shown in FIG. 27, the left waveguide connector 100′ is mounted on a bracket 8′ which is similar to the bracket 8 shown in FIG. 9. However, the bracket 8′ does not have a pair of guiding blocks 83. Each deformable arm 84′ includes a protuberant inner surface for abutting against the left waveguide connector 100′.

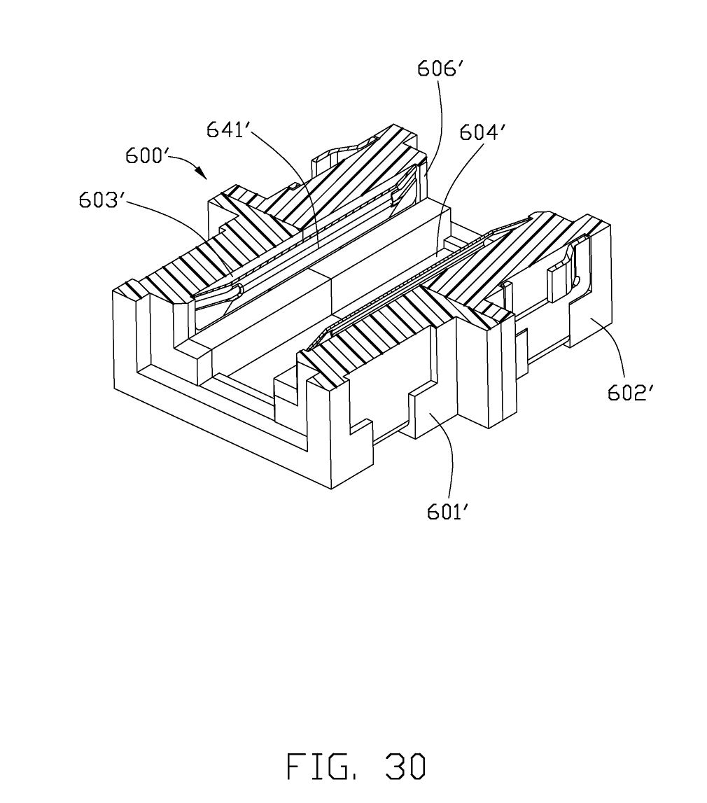

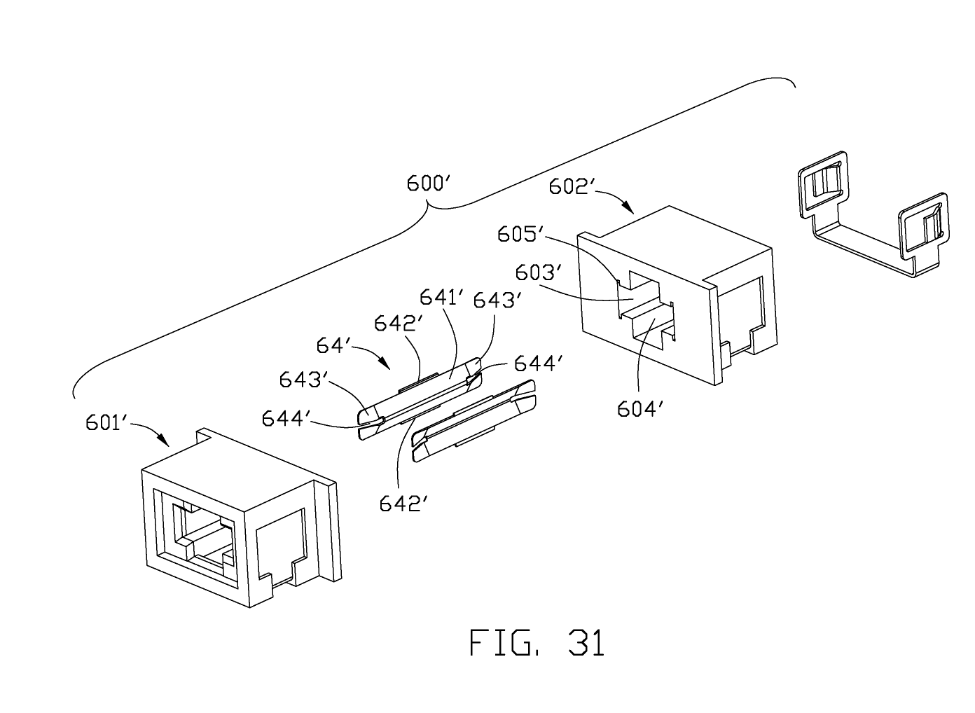

Referring to FIGS. 30 and 31, the coupler 600′ includes a first half housing 601′, a second half housing 602′ combined with the first half housing 601′ with ultrasonic-weld, and a pair of alignment guides 64′. The first half housing 601′ and the second half housing 602′ are symmetrical, so only the second half housing 602′ is detailedly described. As shown in FIG. 31, the second half housing 602′ includes a receiving cavity 604′ for receiving the waveguide connector 100′, and a pair of mounting slots 603′ at lateral sides of the receiving cavity for fixing the alignment guides 64′.

Each alignment guides 64′ includes a body portion 641′ for surfacely attaching the V-shaped grooves 120′ of the waveguide connectors 100′, and a pair of ends 643′ extending from the body portion 641′ along opposite directions. The body portion 641′ has a V-shaped cross section and includes a pair of blocks 642′ protruding from top and bottom sides thereof. Each end 643′ includes a slit 644′ extending therethrough for deformation of the body portion 641′ and manufacturing the body portion 641′ as well. In assembly, one end 643′ of each alignment guides 64′ is inserted into the mounting slot 603′ of the second half housing 602′ along an insertion direction till the one end 643′ is restricted by a first stop wall 606′. A gap is formed inside each body portion 641′ and in communication with the mounting slot 603. The body portion 641′ sidewardly protrudes into the receiving cavity 604′. Meanwhile, the blocks 642′ are fixed in the corresponding slits 605 in order to limit a movement thereof along a direction perpendicular to the insertion direction. Sequently, the second half housing 602′ is mounted to the other end 603′ of the alignment guide 64′. Then, the first and the second half housings 601′, 602′ are fixed together. According to the second embodiment of the present invention, the alignment guides 64′ are stamped from metal sheets. As shown in FIGS. 27, 29 and 30, when the pair of waveguide connectors 100′ are inserted into the coupler 600′ along opposite directions, the V-shaped grooves 120′ of the ferrules 12′ are guided by the body portions 641′ of the alignment guides 64′. In such process, as shown in FIG. 30, the body portions 641′ are engaged against by the V-shaped grooves 120′ of the ferrules 12′ to be deformable in the gaps, so that the pair of waveguide connectors 100′ can be well guided by the alignment guides 64′. Besides, the body portion 641′ of such configuration can provide relative large surface for stably and precisely guiding insertion of the waveguide connectors 100′.

It is to be understood, however, that even though numerous, characteristics and advantages of the present invention have been set forth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. A connector assembly comprising:
a connector comprising an outer housing defining an inner channel, a latching arm and a ferrule both horizontally extending through the inner channel and extending forwardly beyond a front end of the outer housing, the ferrule further extending forwardly beyond the latching arm; and
a bracket for mounting the connector and comprising at least one deformable arm extending upwardly to abut against the outer housing to limit a front-to-back movement of the outer housing.

2. The connector assembly as claimed in claim 1, wherein the bracket comprises a middle portion, a rear base extending backwardly from the middle portion, and a pair of guiding blocks cantileveredly extending forwardly from the middle portion, the ferrule being positioned between the pair of guiding blocks, the at least one deformable arm extending from the rear base.

3. The connector assembly as claimed in claim 2, wherein the pair of guiding blocks extend from a top side of the middle portion and each guiding block comprises a top surface higher than an upper surface of the ferrule, and the latching arm comprises a hook at a distal end thereof, the hook extending upwardly beyond the top surface of each guiding block.

4. The connector assembly as claimed in claim 2, wherein each of the pair of guiding blocks is mainly located in a first plane, and the ferrule is mainly located in a second plane perpendicular to the first plane.

5. The connector assembly as claimed in claim 2, wherein the outer housing comprises a plurality of ribs formed on lateral sides thereof and a positioning slot formed by adjacent ribs to abuttingly receive the at least one deformable arm.

6. The connector assembly as claimed in claim 5, wherein the at least one deformable arm comprises an inner surface configured to attach a convex surface in the positioning slot, and wherein the convex surface comprises an upper part, a lower part and an outmost line formed by the upper and the lower parts, the at least one deformable arm comprising a free end abutting against the upper part in order to limit a bottom-to-top movement of the outer housing.

7. The connector assembly as claimed in claim 2, wherein the connector comprises an elastic member abutting against the outer housing so that the outer housing is backwardly retractable to move the latching arm towards the ferrule along a vertical direction.

8. The connector assembly as claimed in claim 2, wherein the rear base comprises a mounting surface higher than a bottom surface of the middle portion.

9. The connector assembly as claimed in claim 2, wherein the at least one deformable arm is integrally formed with the rear base.

10. The connector assembly as claimed in claim 2, wherein the at least one deformable arm is stamped from a metal sheet and then fixed to the rear base.

11. A connector assembly comprising:
a connector comprising a tube outer housing through which a latching arm and a ferrule both extend;
a bracket for mounting the connector and comprising a middle portion, a rear base extending backwardly from the middle portion, and a pair of guiding blocks cantileveredly extending forwardly from the middle portion, the ferrule being positioned between the pair of guiding blocks, the rear base comprising at least one deformable arm extending upwardly to abut against the outer housing to limit a front-to-back movement of the outer housing; and
a coupler comprising a first receiving opening to receive the ferrule, an abutting wall in communication with the first receiving opening to lock with the latching arm, and a pair of guiding slots formed at lateral sides thereof to guide insertion of the pair of guiding blocks thereinto.

12. The connector assembly as claimed in claim 11, wherein the coupler comprises a pair of protrusions formed at the lateral sides thereof, and the pair of guiding slots extend through the corresponding protrusions so that the pair of guiding blocks are outwardly restricted by the protrusions.

13. The connector assembly as claimed in claim 11, wherein the outer housing comprises a plurality of ribs formed on lateral sides thereof and a positioning slot formed by adjacent ribs to abuttingly receive the at least one deformable arm.

14. The connector assembly as claimed in claim 13, wherein the at least one deformable arm comprises a concave inner surface configured to attach a convex surface in the positioning slot, the convex surface comprising an upper part, a lower part and an outmost line formed by the upper and the lower parts, the at least one deformable arm comprising a free end abutting against the upper part in order to limit a bottom-to-top movement of the outer housing.

15. The connector assembly as claimed in claim 11, wherein the connector comprises an elastic member abutting against the outer housing so that the outer housing is backwardly retractable to drive the latching arm moving towards the ferrule along a vertical direction.

16. The connector assembly as claimed in claim 11, wherein the at least one deformable arm is either unitarily formed with the rear base, or stamped from a metal sheet and then fixed to the rear base.

17. A connector assembly comprising:
a coupler defining therein a mating cavity with two opposite openings at two ends of said mating cavity along an axial direction;
a pair of optical connectors respectively inserted into the mating cavity via said two opposite openings and mated with each other; and
a pair of brackets located beside the coupler and adjacent to said opposite openings, respectively; wherein
each of said bracket includes an attachment structure grasping at least one of the coupler and the corresponding connector, thus facilitating engagement between the coupler and said corresponding connector.

18. The connector assembly as claimed in claim 17, wherein said attachment structure further grasps the other, thus restraining relative movement between the coupler and the corresponding connector in the axial direction.

19. The connector assembly as claimed in claim 17, wherein one of said coupler and said corresponding connector further includes a latch structure locked to the other, thus assuring relative positions between said coupler and said corresponding connector along said axial direction.

20. The connector assembly as claimed in claim 17, wherein an alignment guide structure is formed within the coupler to align said pair of optical connectors in said axial direction.
